(19) United States
(12) Patent Application Publication
(10) Pub. No.: US 2008/0075468 A1
(43) Pub. Date: Mar. 27, 2008

(54) Optical transmission device and redundant switch method for the optical transmission device

(75) Inventors: Tsutomu Aiba, Kawasaki (JP); Yuichi Nagaki, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/714,226

(22) Filed: Mar. 6, 2007

(30) Foreign Application Priority Data
Sep. 22, 2006 (JP) 2006-258041

(51) Int. Cl. H04B 10/04; H04B 10/12

(52) U.S. Cl. 398/182

(57) ABSTRACT

When switching over of a first optical transmitting section and a second optical transmitting section is performed, a monitor signal from a monitor section of each of the first optical transmitting section and the second optical transmitting section is supervised. Then, on the basis of each of the monitor signal, an optical switch section provided in each of the first optical transmitting section and the second optical transmitting section is controlled, and an optical level adjusting section provided in each of the first optical transmitting section and the second optical transmitting section is controlled.

### BACKGROUND OF THE INVENTION

1. Field of the Invention

The present invention relates to optical transmission devices and redundant switching methods for the optical transmission devices. In particular, the present invention relates to an optical transmission device including optical transmitting sections having a redundant configuration and is capable of suppressing variation in an optical transmission level, which occurs when the optical transmitting sections are switched over, and to a redundant switching method for such an optical transmission apparatus.

2. Description of the Related Art

Recently, many optical transmission systems have included optical transmission devices that employ configurations in which major functional units, such as optical transmitting sections, optical receiving sections, and optical multiplexing units, are duplexed. These configurations are developed with a view to increasing the reliability of the systems. In particular, many optical transmission devices employ duplex optical transmitting sections having optical components whose characteristics deteriorate due to aging, which affects the characteristics of the optical transmission devices.

In an optical transmission device having optical transmitting sections in such a duplex configuration, when a failure occurs, for example, in one of the optical transmitting sections is which operating as a current system (hereinafter also referred to as a current optical transmitting section), switching from the current optical transmitting section to another optical transmitting section serving as a standby system (hereinafter also referred to as a standby optical transmitting section) may be necessary, so that the stand-by optical transmitting section will newly operate as the current system. This switching of optical transmitting sections results in variation in the level of an optical signal to be transmitted from the optical transmission device even if switching control is performed simultaneously on both the current optical transmitting section and the standby optical transmitting section. Specifically, variation occurs in the transmission level of an optical signal transmitted by the optical transmission device, due to variation between the level of an optical signal which occurs after the current optical transmitting section stops optical transmission and the level of an optical signal which occurs after the stand-by optical transmitting section starts optical transmission. Such an optical transmission apparatus provided with the above optical transmitting sections in the duplex configuration is disclosed in Japanese Unexamined Patent Application Publication No. H6-216847.

There is also a configuration of an optical transmission device, in which both a current optical transmitting section and a standby optical transmitting section transmit optical signals all the time. In this configuration, switching of optical transmitting sections is performed by switching the optical signal transmitted through each of the current optical transmitting section and the standby optical transmitting section, using an optical switch provided in an output portion of each of the optical transmitting sections. However, in this configuration, timing at which the optical switch of the current system performs the switching operation may be different from timing at which the switch of the standby system performs the switching operation, due to the characteristics of the individual optical switches. Thus, when a current optical transmitting section is switched to a standby optical transmitting section so that the standby optical transmitting section will newly operate as the current system, variation occurs in the transmission level of an optical signal to be transmitted from the optical transmission device.

### SUMMARY OF THE INVENTION

As described above, variation in the level of an optical signal transmitted from an optical transmission device occurs when optical transmitting sections in a redundant configuration are switched over. This variation is caused by a difference between operation timings of optical components or the like constituting the individual optical transmitting sections.

The present invention has been made in view of the above circumstances. Accordingly, there is a need for an optical transmission device having redundant optical transmitting sections, which allows variation in the level of an optical signal to be suppressed when switching over of optical transmitting sections is performed.

According to a first aspect of the present invention, an optical transmission device comprises: a first optical transmitting section and a second optical transmitting section, each comprising an optical signal generating section for generating an optical signal to be transmitted, an optical level adjusting section for adjusting the level of the optical signal to be transmitted, an optical switch section for switching the optical signal transmitted from the optical level adjusting section to either one of two output ports, and a monitor section for monitoring the level of the optical signal at each of the two output ports of the optical switch section; an optical coupler section for coupling an optical signal from the first optical transmitting section and an optical signal from the second optical transmitting section and transmitting the coupled optical signal; and a supervisory control section for, when switching over of the first optical transmitting section and the second optical transmitting section is performed, supervising monitor signals from each of the monitor section of the first optical transmitting section and the monitor section of the second optical transmitting section, and on the basis of the monitor signal, controlling the optical switch section of each of the first optical transmitting section and the second optical transmitting section and controlling the optical level adjusting section of each of the first optical transmitting section and the second optical transmitting section.

According to the first aspect of the present invention, an optical transmission device can be provided in which it can be determined that a switching operation of the optical switch section of each of the optical transmitting sections has been completed, and in accordance with the state of each optical switch section, the level of an optical signal to be transmitted from each of the first optical transmitting section and the second optical transmitting section can be adjusted.

According to a second aspect of the present invention, a redundant switching method for an optical transmission device comprises the steps of monitoring the level of an optical signal at each of two output ports of an optical switch section comprised in each of a first optical transmitting section and a second optical transmitting section, adjusting the level of an optical signal transmitted from each of the first optical transmitting section and the second optical transmitting section, so that the level of the optical signal obtained by coupling the optical signal from the first optical transmitting section and the optical signal from the second optical transmitting section is maintained at a predetermined level, and performing a switching operation in the optical switch section of the first optical transmitting section after a switching operation is completed in the optical switch section of the second optical transmitting section, when switching over from the first optical transmitting section to the second optical transmitting section is performed.

According to the second aspect of the present invention, a redundant switching method for an optical transmission device can be provided in which it can be determined that a switching operation of the optical switch section of each of the optical transmitting sections has been completed, and in accordance with the state of each optical switch section, the level of an optical signal to be transmitted from each of the first optical transmitting section and the second optical transmitting section can be adjusted.

According to the present invention, in an optical transmission device having optical transmitting sections in a redundant configuration, variation in the level of an optical transmission signal, which occurs when switching over of the optical transmitting sections in the redundant configuration is performed, can advantageously be suppressed.

### BRIEF DESCRIPTION OF THE DRAWINGS

FIG. 1 illustrates a basic configuration of an optical transmission device according to an embodiment of the present invention;

FIG. 2 illustrates a basic configuration of an optical transmission device according to an embodiment of the present invention;

FIG. 3 illustrates a basic configuration of an optical transmission device according to an embodiment of the present invention;

FIG. 4 illustrates a basic configuration of an optical transmission device and a switching state according to an embodiment of the present invention;

FIG. 5 illustrates a basic configuration of an optical transmission device and a switching state according to an embodiment of the present invention;

FIG. 6 illustrates a basic configuration of an optical transmission device and a switching state according to an embodiment of the present invention;

FIG. 7 illustrates a supervisory control section according to an embodiment of the present invention;

FIG. 8 illustrates operation timings in a switching procedure; and

FIG. 9 is a flowchart illustrating a switching control procedure according to an embodiment of the present invention.

### DESCRIPTION OF THE PREFERRED EMBODIMENTS

In the following, the embodiments of the present invention will be described with reference to the accompanying drawings. Throughout the drawings, like reference numerals are used to designate like or equivalent components.

### First Embodiment

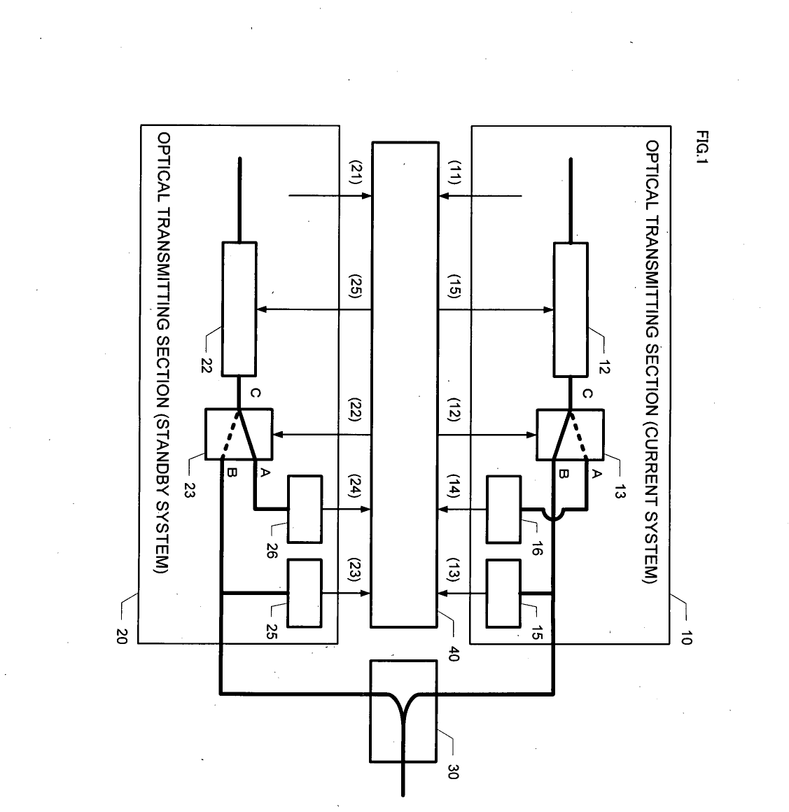

FIG. 1 illustrates a basic configuration of an optical transmission device according to an embodiment of the present invention. The optical transmission device includes an optical transmitting section 10 operating as a current system, which converts an input signal into an optical signal and transmits the optical signal having a predetermined optical level and an optical transmitting section 20 operating as a standby system, which has a configuration similar to the optical transmitting section 10. The optical transmission device also includes an optical coupler section 30 connected to the optical transmitting section 10 and the optical transmitting section 20 through optical cables. The optical coupler section 30 couples an optical signal transmitted from the optical transmitting section 10 and an optical signal transmitted from the optical transmitting section 20 and transmits the coupled signal. The optical transmission device further includes a supervisory control section 40 which is connected to the optical transmitting sections 10 and 20 to supervise and control the optical transmitting sections 10 and 20. The optical transmitting section 10 includes an optical level adjusting section 12, an optical switch section 13, and monitor sections 15 and 16. Similarly, the optical transmitting section 20 includes an optical level adjusting section 22, an optical switch section 23, and monitor sections 25 and 26.

The optical transmitting section 10 sends the supervisory control section 40 a supervisory signal (11) for notifying the supervisory control section 40 of a failure in the optical transmitting section 10, a monitor signal (13) obtained as a result of a monitoring operation of the monitor section 15, and a monitor signal (14) obtained as a result of a monitoring operation of the monitor section 16. The optical transmitting section 10 receives from the supervisory control section 40 a control signal (12) for controlling a connection state of the optical switch section 13 and a control signal (15) for controlling the level of the optical signal in the optical level adjusting section 12.

The optical level adjusting section 12 adjusts the optical level of an input optical signal on the basis of the control signal (15) and outputs the adjusted signal to the optical switch section 13. The optical switch section 13 performs a switching operation in which a port C is connected to either a port A or a port B, on the basis of the control signal (12) received from the supervisory control section 40 and outputs the optical signal input to the port C to either the port A or the port B. The monitor section 15 monitors the optical signal input to the port B and then sends the monitor signal (13) to the supervisory control section 40. The monitor section 16 monitors the optical signal input to the port A and then sends the monitor signal (14) to the supervisory control section 40.

The optical level adjusting section 22, the optical switch section 23, and the monitor sections 25 and 26, which constitutes the optical transmitting section 20, have configurations similar to the optical level adjusting section 12, the optical switch section 13, and the monitor sections 15 and 16, which constitute the optical transmitting section 10, respectively.

In a normal state, that is, in a state in which no factor occurs which causes switching of optical transmitting sections (switching factor), the supervisory control section 40 sends the control signal (12) to the optical switch section 13 of the optical transmitting section 10 to perform control so that the port C is connected to the port B. In the normal state, the supervisory control section 40 also sends the control signal (22) to the optical switch section 23 of the optical transmitting section 20 to perform control so that the port C is connected to the port A. Further, the supervisory control section 40 generates and outputs the control signal (15) for controlling the optical level adjusting section 12 so that the level of an optical signal at the port B of the optical switch section 13 is at a predetermined level, on the basis of the monitor signal (13) obtained as a result of monitoring of the optical signal output from the port B. The supervisory control section 40 also generates and output a control signal (25) for controlling the optical level adjusting section 22 so that the level of an optical signal output from a port A of the optical switch section 23 is at a predetermined level, on the basis of a monitor signal (24) obtained as a result of monitoring of the output optical signal.

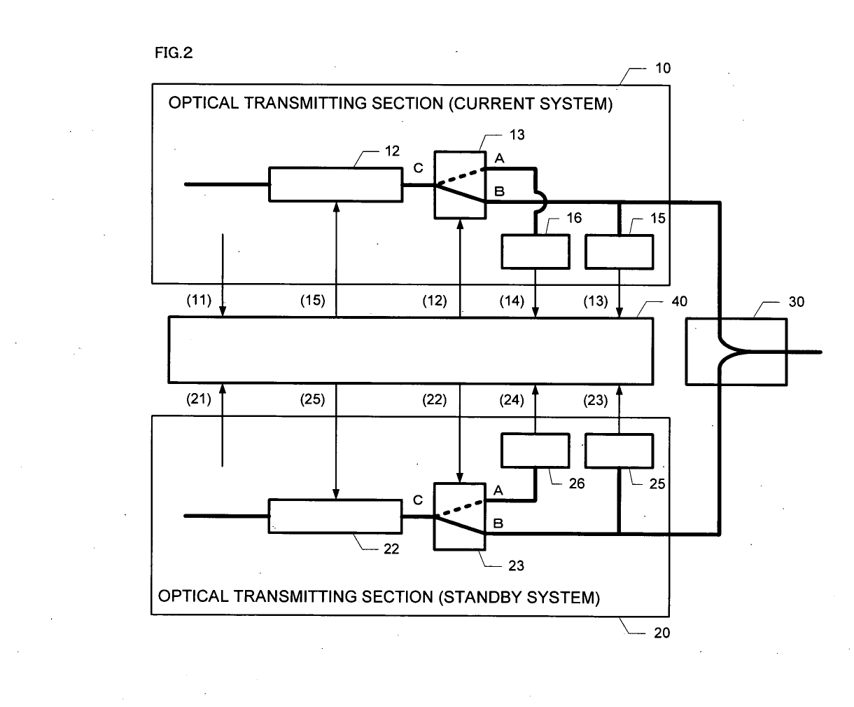

Referring now to FIG. 2, a state in which switching of optical transmitting sections is in progress is illustrated. In this operation, the optical transmitting section 10, which is currently operating as the current optical transmitting section, is switched to the optical transmitting section 20, which is currently operating as the standby-by optical transmitting section, so that the optical transmitting section 20 will operate as the current optical transmitting section. It can be seen from the figure that the connection state of the optical switch section 23 illustrated in FIG. 2 is different from that illustrated in FIG. 1, in that the port C is connected to the port B. The connection state of the optical switch section 13 is the same in both FIG. 1 and FIG. 2.

In the state illustrated in FIG. 1, for example, the supervisory control section 40 determines that a failure occurs in the optical transmitting section 10 operating as the current system, using the supervisory signal (11) and that no failure occurs in the optical transmitting section 20 operating as the standby system, using a supervisory signal (21). Then, the supervisory control section 40 executes control for switching of the optical transmitting section 10 to the optical transmitting section 20. As a result, the connection state as illustrated in FIG. 2 is obtained. In the following, this control operation will be described.

The supervisory control section 40 sends a control signal (22) to the optical switch section 23 to perform control so that the port C and the port B are connected. Then, the supervisory control section 40 determines that the destination port to be connected to the port C has been changed from the port A to the port B. This can be determined by detecting using a monitor signal (23) that the optical signal level at the port B of the optical switch section 23 has increased and detecting using a monitor signal (24) that the optical signal level at the port A of the optical switch section 23 has decreased. The supervisory control section 40 supervises the levels of optical signals at the optical transmitting section 10 using the monitor signal (13) and the monitor signal (23). Then, the supervisory control section 40 generates and outputs the control signals (15) and (25) for controlling the optical level adjusting sections 12 and 22, respectively, such that the optical signal level monitored by the monitor section 15 is gradually decreased and the optical signal level monitored by the monitor section 25 is gradually increased, and such that the sum of the individual optical signal levels is maintained to be a predetermined value.

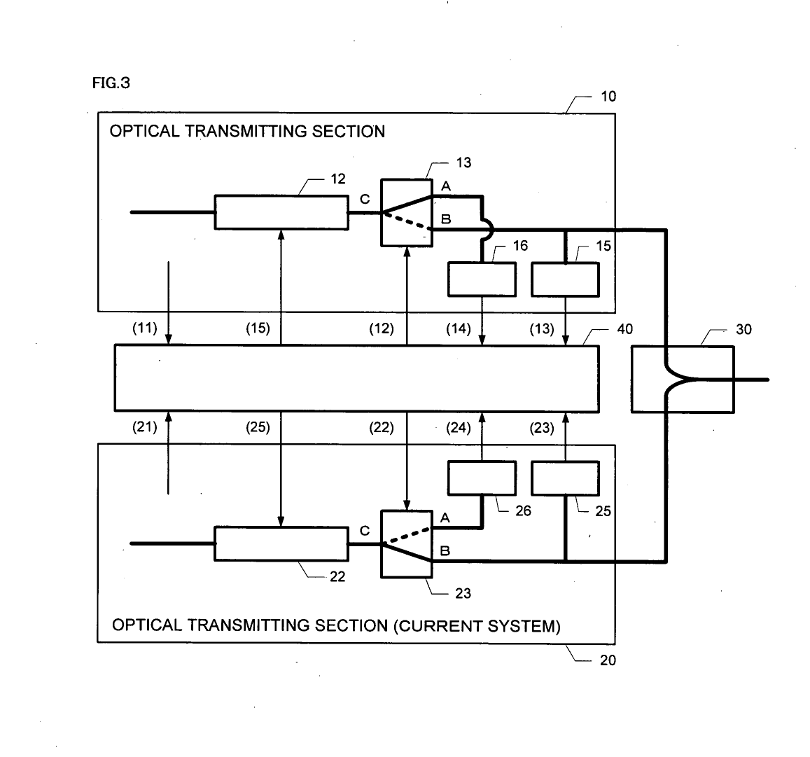

FIG. 3 illustrates a state in which the switching from the optical transmitting section 10 to the optical transmitting section 20 has been completed. It can be seen from the figure that the connection state of the optical switch section 13 illustrated in FIG. 3 is different from that illustrated in FIG. 2, in that the port C is connected to the port A. The connection state of the optical switch section 23 is the same in both FIG. 2 and FIG. 3.

The supervisory control section 40 sends the control signal (12) to the optical switch section 13 of the optical transmitting section 10 to perform control so that the port C is connected to the port A, when determining by supervising the monitor signal (13) in the state of FIG. 2 that the level of an optical signal transmitted from the optical transmitting section 10 has been decreased sufficiently. As a result of the transmission of this control signal (12), the state illustrated in FIG. 3 is obtained.

The supervisory control section 40 generates and outputs the control signal (25) for controlling the optical level adjusting section 22 so that the optical signal level at the port B is at a predetermined level, on the basis of the monitor signal (23) obtained through monitoring of the optical signal output from the port B of the optical switch section 23.

As described above using FIG. 1 to FIG. 3, by using the monitor sections 15 and 16, and the monitor sections 25 and 26, the supervisory control section 40 can determine that the switching operation performed in each of the optical switch section 13 and the optical switch section 23 has been completed. In addition, control is performed such that the signal level of the optical signal obtained by coupling the optical signals from the optical transmitting sections 10 and 20 is maintained at a predetermined level, after switching operation in the optical switch section 23 of the optical transmitting section 20 is completed. Thus, variation in the optical level of an optical signal to be transmitted from the optical transmission device can be suppressed when switching of from the current optical transmitting sections to the standby optical transmitting section is performed.

### Second Embodiment

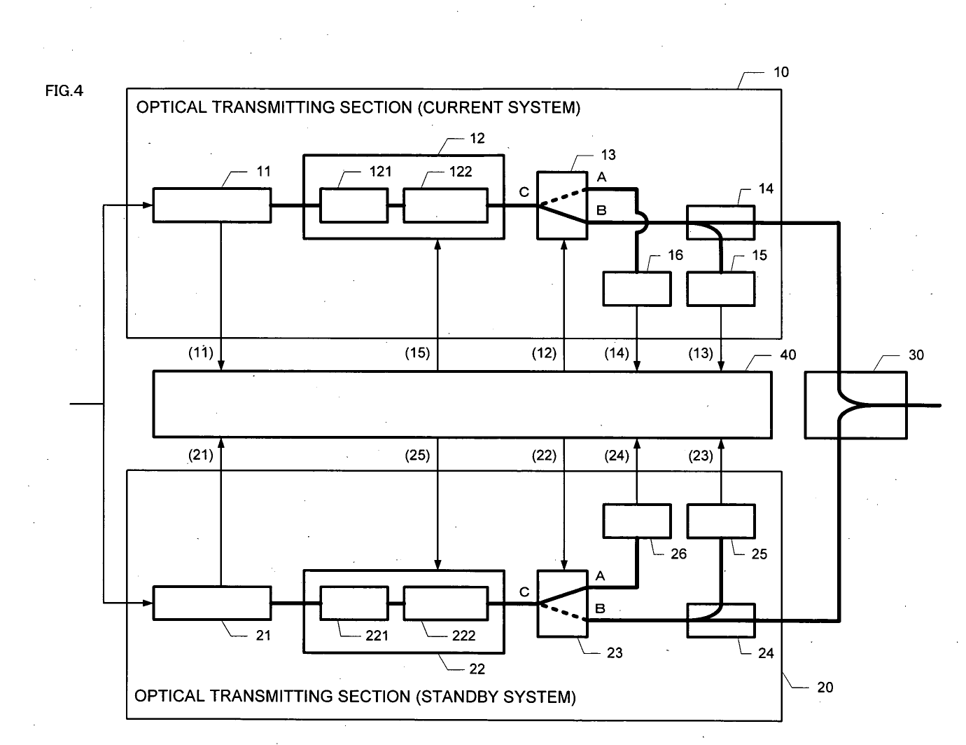

Each of FIGS. 4 to 6 illustrates a configuration of an optical transmission device and a state in a switching process according to an embodiment of the present invention. FIGS. 4 to 6 correspond to FIGS. 1 to 3, respectively.

The optical transmission device includes an optical signal generating section 11 for generating an optical signal to be transmitted to an optical level adjusting section 12.

The optical level adjusting section 12 includes an optical amplifying section 121 and an optical variable attenuating section 122. The optical amplifying section 121 amplifies an input optical signal to a predetermined level. The optical variable attenuating section 122 attenuates the input optical signal on the basis of a control signal (15). By means of the operations of the optical amplifying section 121 and the optical variable attenuating section 122, the optical signal level at a port C of the optical switch section 13 is maintained at a predetermined level. That is, the optical level adjusting section 12 adjusts the optical level of an optical signal to be transmitted from an optical transmitting section 10 to the predetermined level.

An optical switch section 13 connects the port C to either a port A or a port B, on the basis of a control signal (12) provided by a supervisory control section 40 and thus outputs an optical signal input to the port C to either the port A or the port B.

The optical transmitting section 10 also has an optical distributing section 14 for distributing an optical signal input to the port B of the optical switch section 13 to an optical coupler section 30 and to a monitor section 15.

The monitor section 15 monitors the optical signal input to the port B of the optical switch section 13 and provides a monitor signal (13) to the supervisory control section 40.

A monitor section 16 monitors the optical signal input to the port A of the optical switch section 13 and provides a monitor signal (14) to the supervisory control section 40.

An optical transmitting section 20 includes an optical signal generating section 21, an optical amplifying section 221, an optical variable attenuating section 222, the optical switch section 23, an optical distributing section 24, and monitor sections 25 and 26. These components are similar to the optical signal generating section 11, the optical amplifying section 121, the optical variable attenuating section 122, the optical switch section 13, the optical distributing section 14, and the monitor sections 15 and 16, respectively, which constitute the optical transmitting section 10.

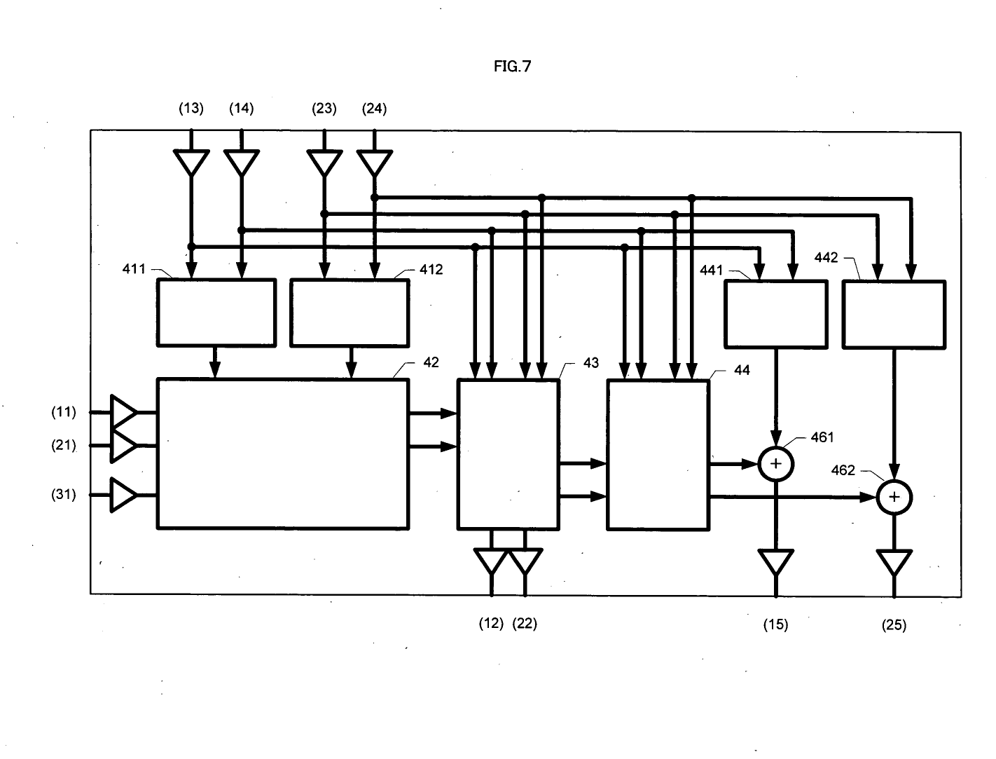

FIG. 7 illustrates the supervisory control section 40 according to the second present embodiment of the present invention. The supervisory control section 40 includes a monitor level supervisory section 411 for supervising the level of an optical signal output from each of the port A and the port B of the optical switch section 13 using the monitor signals (14) and (13), respectively. The supervisory control section 40 also includes a monitor level supervisory section 412 for supervising the level of an optical signal output from each of the port A and the port B of the optical switch section 23 using the monitor signals (24) and (23), respectively. When it is determined that a failure (switching factor) has occurred, as the result of the supervising operation of each of the monitor level supervisory sections 411 and 412, an alarm supervisory section 42 is notified of the failure of the monitor level, which will be described below.

The alarm supervisory section 42 can receive a notification from the optical transmitting section 10 or 20 through the supervisory signal (11) or (12), respectively, of a failure in the optical signal generating section 11 or 12, respectively. The alarm supervisory section 42 can also receive a notification of a failure in the monitor level from the monitor level supervisory section 411 or the monitor level supervisory section 412, and a notification of a current-standby switching signal (31) for performing switching of optical transmitting sections for maintenance. In response to any of these notifications, the alarm supervisory section 42 generates an alarm signal indicative of the failure or the abnormal state of any of the current optical transmitting section and the standby optical transmitting section and sends the generated alarm signal to an optical switching control section 43.

On the basis of the alarm signal sent transmitted from the alarm supervisory section 42, the optical switch control section 43 supervises the connection state of the optical switch sections 13 and 23 using the monitor signals (13) and (14), and (23) and (24), respectively. Then, the optical switch control section 43 generates control signals (12) and (22) for controlling the connection of the optical switch sections 13 and 23, respectively. In addition, the optical switch control section 43 transmits signals equivalent to the control signals (12) and (22) to a level control section B 44, which will be described below.

A level control section A 441 included in the supervisory control section 40 generates a control signal for setting the level of an optical signal to be output from the optical level adjusting section 12 to a predetermined level, on the basis of the monitor signals (13) and (14). Similarly, a level control section A 442, which is also included in the supervisory control section 40, generates a control signal for setting the level of an optical signal to be output from the optical level adjusting section 22 to a predetermined level, on the basis of the monitor signals (23) and (24).

During the switching of optical transmitting sections described using FIG. 2, the level control section B 44 generates a control signal control the amount of attenuation in each of the optical level adjusting sections 12 and 22. For example, in the case of FIG. 2, the level control section B 44 generates a control signal for increasing the amount of attenuation in the optical level adjusting section 12 and a control signal decreasing the amount of attenuation in the optical level adjusting section 22.

An adder section 461, included in the supervisory control section 40, adds the control signal generated by the level control section A 441 and the control signal generated by the level control section B 44 for the current system, so as to generate the control signal (15). An adder section 462, also included in the supervisory control section 40, adds the control signal generated by the level control section A 442 and the control signal generated by the level control section B 44 for the standby system, so as to generate the control signal (25).

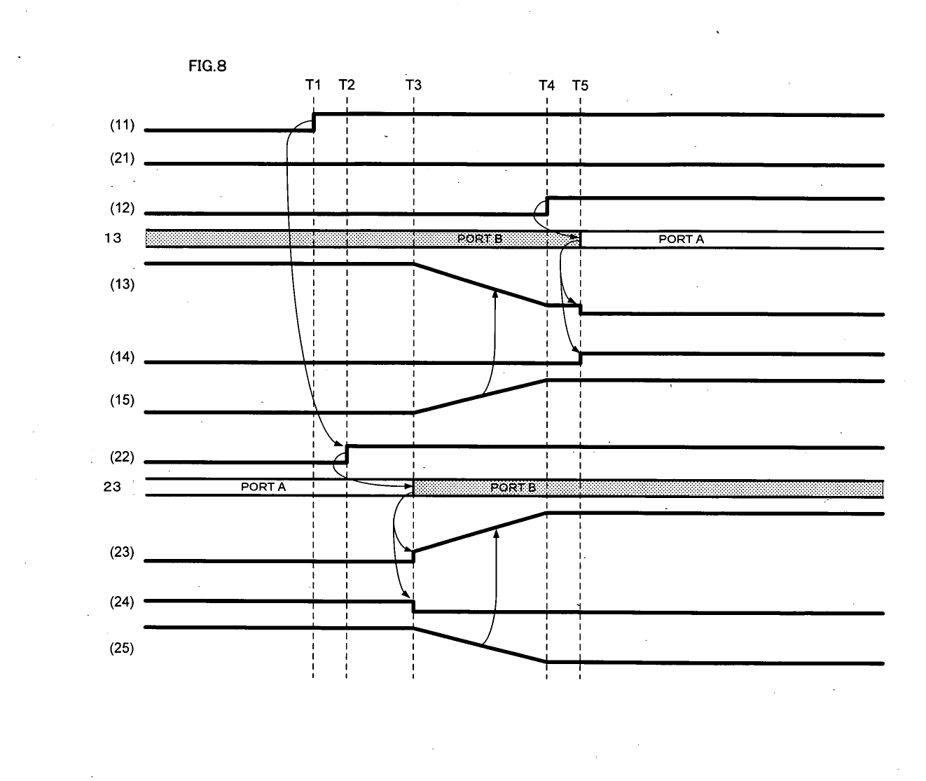

Referring to FIG. 8, operation timings in the above switching of optical transmitting sections are illustrated. The figure illustrates the states of the signals related to the supervisory control section 40 and the connection states of the optical switch sections 13 and 14, in the switching from the optical transmitting section 10 (current system) to the optical transmitting section 20 (standby system) which is performed in the optical transmission device.

In the figure, a time point T1 indicates the time point at which an alarm causing the switching of the optical transmitting section 10 (current system) is generated.

A time point T2 indicates the time point at which the optical switch section 23 of the optical transmitting section 20 (standby system) is controlled to start a switching operation in response to the alarm generated at T1.

A time point T3 indicates the time point at which the switching operation of the optical switch section 23 is completed.

A time point T4 indicates the time point at which the optical switch section 13 of the optical transmitting section 10 (current system) is controlled to start a switching operation.

A time point T5 indicates the time point at which the switching operation of the optical switch section 13 is completed.

Referring to FIG. 4 to FIG. 8, operations of the optical transmission device for executing the switching of optical transmitting sections will be illustrated.

FIG. 4 illustrates a state before the time point T1 shown in FIG. 8, in which the optical transmitting section 10 operates as the current optical transmitting and the optical transmitting section 20 operates as the standby optical transmitting unit.

Now, the optical transmitting section 10 as the current optical transmitting section will be described.

The optical signal generating section 11 converts an input electric signal into an optical signal so as to transmit the optical signal to the optical level adjusting section 12.

The optical amplifying section 121 of the optical level adjusting section 12 amplifies the optical signal received from the optical signal generating unit 11, so that the optical signal has a predetermined optical level. The optical variable attenuating section 122 of the optical level adjusting section 12 attenuates the optical signal on the basis of the control signal (15) so that the optical signal to be output from the optical level adjusting unit 12 has a predetermined level.

The optical switch section 13 connects the port C to either the port A or the port B, on the basis of the control signal (12). In the state before the time point T1, the port C is connected to the port B. This state is maintained until the time point T4 at which the optical switch section 13 starts the switching operation, which will be described below.

The optical distributing section 14 distributes the optical signal received from the port B of the optical switch section 13 in a 9 to 1 ratio, for example, to the optical coupler section 30 and to the monitor section 15. For example, the optical distributing section 14 outputs 90 percent of the optical signal as the transmitted signal of the optical transmitting section 10 and 10 percent of the optical signal as the signal to be monitored by the monitor section 15.

The monitor section 15 monitors the distributed optical signal using a photodiode, for example, and sends the monitor signal (13) to the supervisory control section 40.

The monitor section 16 monitors the optical signal received from the port A using a photodiode, for example, and sends the monitor signal (14) to the supervisory control section 40. Note that the no optical signal is output from the port A until the time point T4.

Next, the optical transmitting section 20 operating as the standby optical transmitting section will be described.

The optical signal generating section 21 has a configuration similar to the optical signal generating section 11. The optical signal generating section 21 converts a received electric signal having the same signal level as the signal level of the electric signal input to the optical signal generating section 11 into an optical signal so as to be transmitted to the optical level adjusting section 22.

The optical level adjusting section 22 has a configuration similar to the optical level adjusting section 12. The optical amplifying section 221 amplifies the received optical signal so that the optical signal has a predetermined optical level. The optical variable attenuating section 222 attenuates the optical signal so that the optical level of the optical signal to be output has a predetermined level, on the basis of the control signal (25). However, since the optical transmitting section 20 operates as the standby optical transmitting section, the control signal (25) controls the optical variable attenuating section 222 to attenuate the optical signal to the extent that the presence or absence of the optical signal can be determined. Such control is continued until the time point T3.

The optical switch section 23 connects the port C to either the port A or the port B on the basis of the control signal (22). In the state before the time point T1, the port C is connected to the port A. This state is maintained until the time point T2.

The optical distributing section 24 distributes the optical signal received from the port B of the optical switch section 23 in a 9 to 1 ratio, for example, to the optical coupler section 30 as an output signal of the optical transmitting section 20 and to the monitor section 25. For example, the optical distributing section 24 outputs 90 percent of the optical signal as the output signal of the optical transmitting section 20 and 10 percent of the optical signal as the signal to be monitored by the monitor section 25.

The monitor section 25 monitors the distributed optical signal using a photodiode, for example, and sends the monitor signal (23) to the supervisory control section 40.

The monitor section 26 monitors the optical signal output from the port A using a photodiode, for example, and sends the monitor signal (24) to the supervisory control section 40. Note that the optical signal from the port A continues to be significantly attenuated until the time point T2.

The optical coupler section 30 couples the optical signal output from the optical transmitting section 10 and the optical signal output from the optical transmitting section 20 and transmits the coupled optical signal. In the state illustrated in FIG. 4 where no optical signal is output from the optical transmitting section 20 as the standby optical transmitting section, the optical coupler section 30 transmits the optical signal transmitted from the optical transmitting section 10 operating as the current optical transmitting section.

In the state illustrated in FIG. 4, where the optical transmitting section 10 is operating as the current optical transmitting section, i.e., the state before the time point T1, the optical switch control section 43 of the supervisory control section 40 illustrated in FIG. 7 generates the control signals (12) and (22) for controlling the connection states of the optical switch sections 13 and 14, respectively.

The level control section B 44 determines that switching has not been performed on the basis of a signal sent from the optical switch control section 43 and sends the adder section 462 a signal for adding a predetermined amount of attenuation in the optical variable attenuating section 222. As described above, the optical signal to be output from optical level adjusting section 22 is attenuated by the predetermined amount of attenuation, such that the presence or absence of the optical signal at the port A can be determined using the monitor signal (24).

The level control section A 441 generates a signal for controlling the amount of attenuation on the basis of the monitor signal (13), so that the monitor level maintains a constant level.

The level control section A 442 does not generate a control signal since the monitor signal (23) is not transmitted, in the state illustrated in FIG. 4.

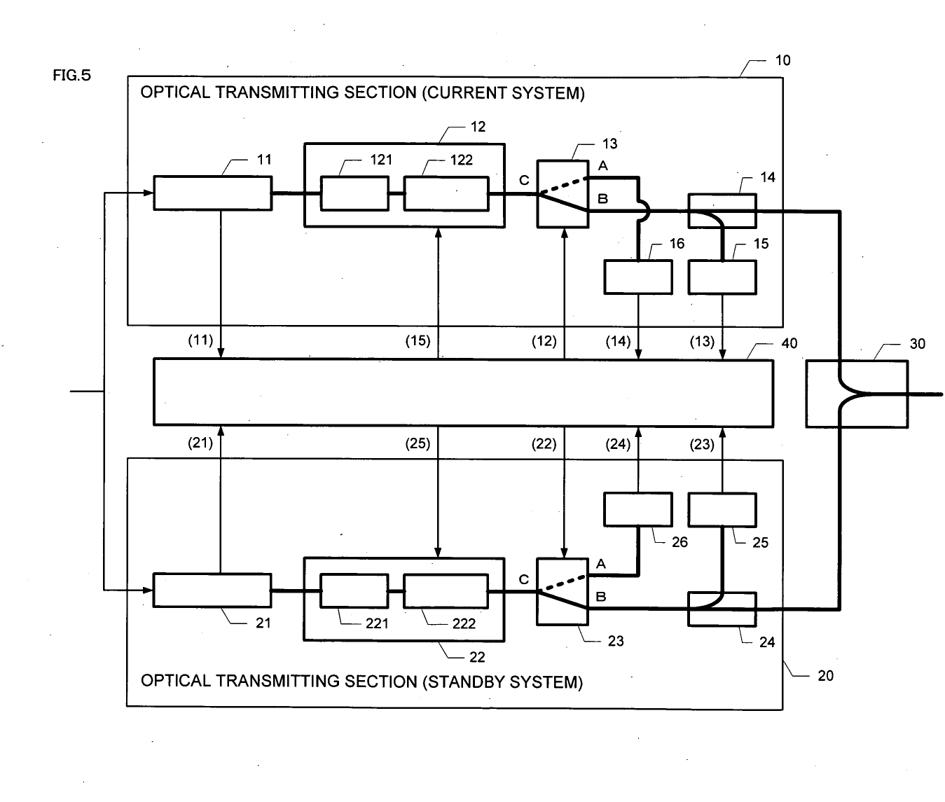

FIG. 5 illustrates a state in which a switching operation has performed in the optical switch section 23 of the optical transmitting section 20 as the standby optical transmitting section, for a factor causing the switching of the current optical transmitting section. In the following, the time points T1 to T4 will be described.

First, the optical transmission device in the state illustrated in FIG. 4 will be described.

At the time point T1, an alarm serving as a factor that causes switching over of current optical transmitting sections is generated (supervisory signal (11)). Such an alarm is generated due to, for example, a failure in a laser-diode current in the optical signal generating section 11. On the other hand, at the time point T1, the optical transmitting section 20 is in the normal state (supervisory signal (21)).

On the basis of the supervisory signal (11) generated at the time point T1, the alarm supervisory section 42 determines that the optical transmitting section 20 is in the normal state by using the supervisory signal (21) and that no failure occurs in the optical signal from the optical transmitting section 20 by means of the notification sent from the monitor level supervisory section 412. Then the alarm supervisory section 42 notifies the optical switch control section 43 of the failure in the optical transmitting section 10 and of the normal state of the optical transmitting section 20. The optical switch control section 43 determines the connection states of the optical switch sections 13 and 14 respectively, by detecting through the monitor signals (13) and (24), respectively, that the optical signals are transmitted through the port B of the optical switch section 13 and the port A of the optical switch section 23, and by detecting through the monitor signals (14) and (23), respectively, that no optical signals are transmitted through the port A of the optical switch section 13 and the port B of the optical switch section 23. Then, the optical switch control section 43 generates the control signal (22) for performing a switching operation in the optical switch section 23.

At the time point T2 is the timing at which this control signal (22) is generated.

The time point T3 is the timing at which the connection state of the optical switch section 23 is changed in response to the control signal (22), such that the port C is connected to the port B, as illustrated in FIG. 5. This switching operation of the optical switch section 23 changes the state of the monitor section 25 from the state without optical signal output (monitor signal (23)) to the state with optical signal output. The switching operation also changes the state of the monitor section 26 from the state with optical signal output (monitor signal (24)) to the state without optical signal output.

Next, the state illustrated in FIG. 5 will be described in conjunction with the time points T3 and T4 illustrated in FIG. 8.

The level control section B 44 receives from the optical switch control section 43 signals equivalent to the control signals (12) and (22) for controlling the connection states of the optical switch sections 13 and 14, respectively, so as to determine that switching operation of the optical switch section 23 has been completed (the time point T3).

Then, the level control section B 44 adjusts the amount of control of the control signals (15) and (25) on the basis of the monitor levels obtained through the monitor signals (13) and (23), respectively. In this adjustment operation, the amount of attenuation in the optical variable attenuating section 122 of the current optical transmitting section is gradually increased, and the amount of attenuation in the optical variable attenuating section 222 of the standby optical transmitting section is gradually decreased, such that the level of the coupled signal to be output from the optical coupler section 30 is maintained at a predetermined level (the time point T3 to the time point T4).

The amount of control of the control signals (15) and (25) are determined on the basis of the length of time necessary for the switching over of the optical transmitting sections, which depends on the type (specifications) of optical transmission device.

The time point T4 is the time at which the switching operation of the optical switch section 13 (current system) starts.

The optical switch control section 43 determines that the amount of attenuation in the optical variable attenuating section 122 has been increased and the level of the optical signal output from the current system has been lowered sufficiently to a predetermined level or lower, on the basis of the monitor signal (13) indicative of the optical level of the transmission signal from the current optical transmitting section. Then, the optical switch control section 43 generates the control signal (12) for performing the switching operation of the optical switch section 13 of the current optical transmitting section.

The level control section B 44 is notified of the switching operation of the optical switch section 13 from the optical switch control section 43. The level control section B 44 then adjusts the amount of control of each of the control signals (15) and (25), such that the current state of the control of the amount of attenuation performed on each of the optical variable attenuating sections 122 and 222, respectively, is maintained.

The timing T5 is the timing at which the connection state of the optical switch section 13, which has received the above control signal (12), has been changed, such that the port C is connected to the port A. This switching operation of the optical switch section 13 changes the state of the monitor section 15 from the state without optical signal output (monitor signal (13)) to the state with optical signal output. The switching operation also changes the state of the monitor section 16 from the state with optical signal output (monitor signal (14)) to the state without optical signal output.

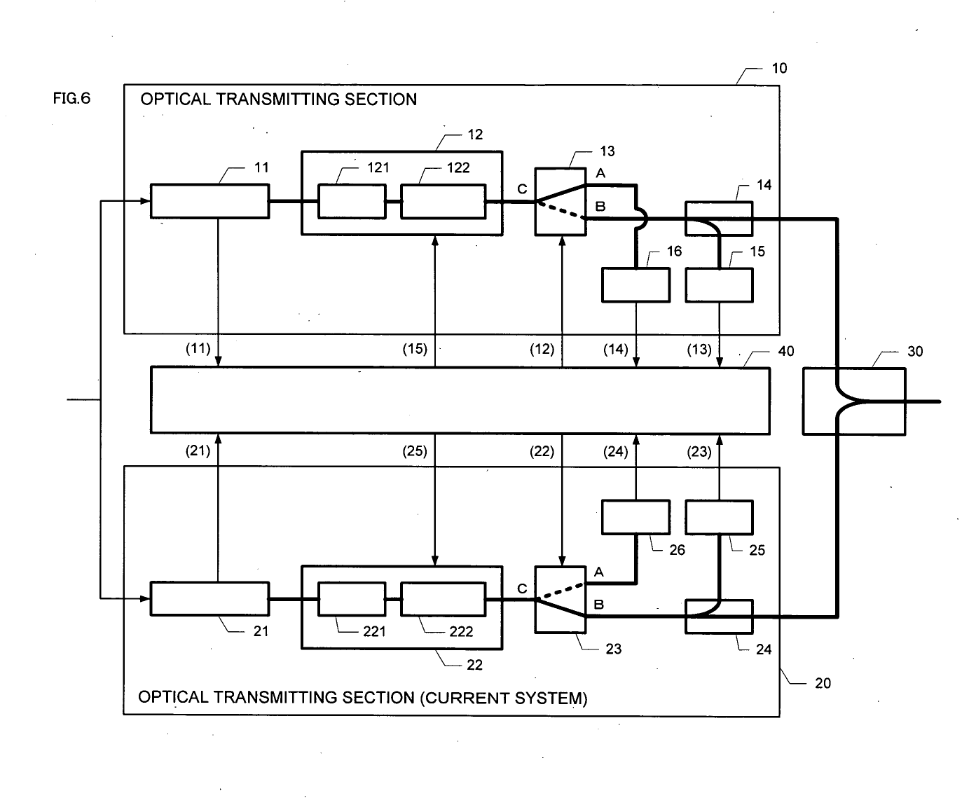

FIG. 6 illustrates the state of the optical transmission device, in which the switching operation of the optical switch section 13 has been completed and thus the optical transmitting section 20 operates as the current optical transmitting section. The optical transmission device enters this state at the time point T5.

At the time point T5 and thereafter, an optical signal to be transmitted from the optical transmission device corresponds to the optical signal transmitted from the optical transmitting section 20. The level control section A 442 generates the control signal (25) so that the level of the optical signal to be output from the optical transmission device is maintained at a predetermined level, on the basis of the monitor signal (23).

In the foregoing description, a failure occurs in the optical signal generating section 11 as a factor that causes the switching over of the optical transmitting sections, which is notified by the supervisory signal (11). However, a failure in the level of the optical signal transmitted through the current system, which is detected by the monitor level supervisory section 411, can be the factor that causes the switching. Further, as described using FIG. 7, the switching over of optical transmitting sections can also be permitted on the basis of the current-standby switch signal (31) generated when the switching over of optical transmitting sections is performed for maintenance.

In the following, the optical signal levels at the port As and the port Bs of the optical switch sections 13 and 23 and the optical distributing sections 14 and 24 for distributing an optical signal to be output from the port Bs, in the above switching over of optical transmitting sections, will further be described.

In the state illustrated in FIG. 4, no optical signal is output to either the port A of the optical switch section 13 or the port B of the optical switch section 23. The optical signal level at the port B of the optical switch section 13 is set to generally equal to a constant level of the optical signal output from the optical transmission device, by the effect of the operation of the optical variable attenuating section 122 based on the control signal (15). Then, the optical signal level of the port A of the optical switch section 23 is lowered to a predetermined low level, by the effect of the operation of the optical variable attenuating section 222 based on the control signal (25).

In the state illustrated in FIG. 5, no optical signal is output to either the port A of the optical switch section 13 or the port B of the optical switch section 23. The optical signal level at the port B of the optical switch section 13 is gradually lowered from the optical signal level of the output signal of the optical transmission device to a predetermined low level, by the effect of the operation of the optical variable attenuating section 122 based on the control signal (15). The optical signal level at the port B of the optical switch section 23 is gradually raised from the predetermined low level to the optical signal level of the output signal of the optical transmission device, by the effect of the operation of the optical variable attenuating section 222 based on the control signal (25).

In the state illustrated in FIG. 6, no optical signal is output to both the port B of the optical switch section 13 and the port A of the optical switch section 23. The optical signal level at the port A of the optical switch section 13 is lowered to a predetermined low level, by the effect of the operation of the optical variable attenuating section 122 based on the control signal (15). The optical signal level at the port A of the optical switch section 23 is set to generally equal to the constant level of the optical output signal from the optical transmission device, by the effect of the operation of the optical variable attenuating section 222 based on the control signal (25).

As described above, the monitor sections 15 and 25 monitor the levels of the optical signals which are significantly changed during switching over of optical transmitting sections, and the monitor sections 16 and 26 monitor the predetermined low level of the optical signals. With this arrangement, the optical variable attenuating section 122 and the optical variable attenuating section 222 are controlled.

Thus, the levels of optical signals, which are distributed from the optical distributing sections 14 and 24 and are to be monitored by the monitor sections 15 and 25 are determined on the basis of the control schemes employed in the level control section As 441 and 442 and the level control section B 44 that generate the control signals (15) and (25). These level control sections generate the control signals (15) and (25) on the basis of a range of the optical levels monitored by the monitor sections 15 and 25, the level of the optical signal output from the optical transmission device, and the optical levels monitored by the monitor sections 16 and 26, and thus the distribution ratios for the optical distributing sections 12 and 24 is also determined.

In the foregoing, completion of a switching operation of an optical switch section can be detected by monitoring an optical signal at each of two output ports of the optical switch section. When a switching operation is performed in the optical switch section of a current optical transmitting section after a switching operation is completed in the optical switch of a standby optical transmitting section, the level of a coupled optical signal, which is obtained by coupling an optical signal output from the current optical transmitting section and the optical signal output from the standby optical transmitting section, is maintained at a predetermined level. At the same time, the level of the optical signal output from the current optical transmitting section is gradually lowered. With this arrangement, variation in the level of optical signal, which occurs due to the switching over of optical transmitting sections, can be suppressed.

### Third Embodiment

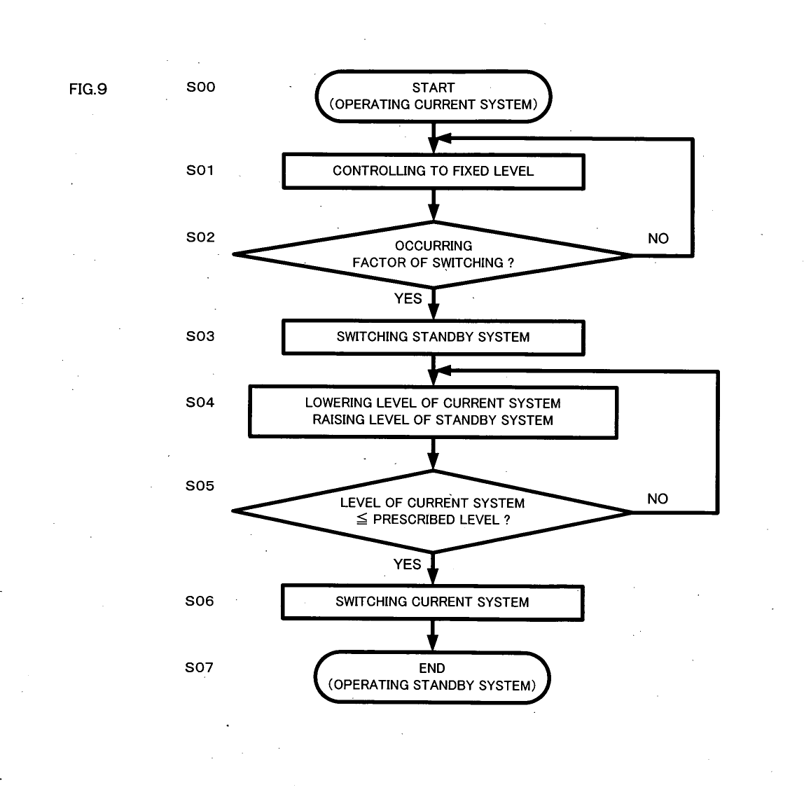

FIG. 9 is a flowchart illustrating a procedure of switching control according to the present embodiment.

When the procedure starts at STEP S00, an optical transmitting section 10 is operating as a current optical transmitting section as illustrated in FIG. 1 and FIG. 4.

At STEP S01, in the optical transmitting section 10, a level control section A441 of a supervisory control section 40 controls a optical level adjusting section 12 on the basis of a monitor signal (13) obtained from a monitor section 15, so that the level of the optical signal output from the optical transmitting section 10 is maintained at a predetermined level.

At STEP S02, the supervisory control section 40 determines whether or not a factor causing the switching over of optical transmitting sections occurs, such as an alarm notifying of a failure. The failure may be an LD-current failure in an optical signal generating section 11 or a failure in a monitor signal level in a monitor level supervisory section 411, for example. A switch instruction for maintenance can also be a switch factor.

If it is determined in STEP S02 that a switch factor has occurred, then at STEP S03, the supervisory control section 40 generates and sends an optical switch section 23 of an optical transmitting section 20 (standby system) a control signal (22) for performing a switching operation. In response to the control signal (22), the optical switch section 23 performs the switching operation.

At STEP S04, the supervisory control section 40 determines that the switching operation of the optical switch section 23 has been completed, and generates and sends the optical level adjusting section 12 of the optical transmitting section 10 (current system) the control signal (15) so that the level of the optical signal to be output is gradually lowered. The supervisory control section 40 also generates and sends the optical level adjusting section 22 of the optical transmitting section 20 (standby system) the control signal (25) so that the level of the optical signal to be output is gradually raised. An optical variable attenuating section 122 of the optical level adjusting section 12 increases the amount of attenuation on the basis of the control signal (15), and an optical variable attenuating section 222 of the optical level adjusting section 22 decreases the amount of attenuation on the basis of the control signal (25). At the same time, the supervisory control section 40 performs control so that the level of the coupled optical signal, which is obtained by coupling the optical signal from the optical transmitting section 10 and the optical signal from the optical transmitting section 20, is maintained at a predetermined level. In this control, a level control section B 44 obtains the level of the coupled optical signal on the basis of the monitor signals (13) and (23), and causes the optical variable attenuating section 122 to attenuate an input optical signal by a predetermined amount at a predetermined time point, and thus the amount of attenuation of the optical variable attenuating section 222 of the optical transmitting section 20 is adjusted.

At STEP S05, the level control section B 44 of the supervisory control section 40 determines on the basis of the monitor signal (13) whether or not the level of the optical signal output from the optical transmitting section 10 (current system) has been lowered to a predetermined level or lower.

If it is determined in STEP S05 that the level of the optical signal output from the optical transmitting section 10 has been lowered to the predetermined level or lower, then at STEP S06, the supervisory control section 40 generates the control signal (12) for causing the optical switch section 13 (current system) to perform a switching operation. In response to the control signal (12), the optical switch section 13 performs the switching operation.

When the process of STEP S06 is completed, the optical transmitting section 20 starts serving as the current optical transmitting section, at STEP S07, and thus the optical transmission device transmits the optical signal output from the optical transmitting section 20.

In the above control procedure, when a switch factor occurs in the optical transmission device, control is performed so that a switching operation is performed in the current optical transmitting section after a switching operation is performed in the standby optical transmitting section, and the level of a coupled signal obtained by coupling optical signals from both the optical transmitting sections is maintained at a predetermined level. By the time when the switching operation of the current optical transmitting section is performed, the level of the optical signal output from the current optical transmitting section has been lowered to the predetermined level or lower. With this arrangement, variation in the level of an optical signal output from the optical transmission device, which occurs when switching over of optical transmitting sections is performed, can be suppressed.

What is claimed is:

1. An optical transmission device comprising:
a first optical transmitting section for transmitting an optical signal;
a second optical transmitting section for transmitting the same optical signal;
an optical coupler section for coupling the optical signal from the first optical transmitting section and the optical signal from the second optical transmitting section, and transmitting the coupled optical signal; and
a supervisory control section for, when switching over the first optical transmitting section and the second optical transmitting section is performed, supervising monitor signals from each of the first optical transmitting section and the second transmitting section, and controlling the optical level of each of the first optical transmitting section and the second transmitting section.

2. The optical transmission device according to claim 1,
wherein each of the first optical transmitting section and the second optical transmitting section comprising:
an optical signal generating section for generating an optical signal;
an optical level adjusting section for adjusting the level of the optical signal;
an optical switch section for switching the optical signal transmitted from the optical level adjusting section to either one of two output ports;
a monitor section for monitoring the level of the optical signal at each of the two output ports of the optical switch section.

3. The optical transmission device according to claim 2,
when switching over from the first optical transmitting section to the second optical transmitting section is performed,
a switching operation is performed in the optical switch section of the first optical transmitting section after a switching operation is completed in the optical switch section of the second optical transmitting section, in accordance with the control of the supervisory control section.

4. The optical transmission device according to claim 2,
wherein the optical level adjusting section comprising:
an optical amplifying section for amplifying the optical signal; and
an optical variable attenuating section for attenuating the optical signal on the basis of the control of the supervisory control section.

5. The optical transmission device according to claim 4,
wherein the supervisory control section controls the each optical variable attenuating section, so that the level of the coupled optical signals is maintained at a predetermined level when switching over of the first optical transmitting section and the second optical transmitting section is performed.

6. The optical transmission device according to claim 2,
wherein the monitor section comprising:
a first monitor portion for monitoring the level of an optical signal outputted from one of the two output ports to the optical coupler section through an optical distributing section for distributing the optical signal to the optical coupler section and to the first monitor portion; and
a second monitor portion for monitoring the level of an optical signal directly provided from the other one of the two output ports.

7. The optical transmission device according to claim 2,
wherein both the optical signal generating section of the first optical transmitting section and the optical signal generating section of the second optical transmitting section generate optical signals having a predetermined level.

8. A redundant switch method for an optical transmission device, the method comprising the steps of:
monitoring the level of an optical signal at each of two output ports of an optical switch section comprised in each of a first optical transmitting section and a second optical transmitting section;
adjusting the level of an optical signal transmitted from each of the first optical transmitting section and the second optical transmitting section, so that the level of the optical signal coupled the optical signal from the first optical transmitting section and the optical signal from the second optical transmitting section is maintained at a predetermined level; and
performing a switch operation in the optical switch section of the first optical transmitting section after a switch operation is completed in the optical switch section of the second optical transmitting section, when switching over from the first optical transmitting section to the second optical transmitting section is performed.

9. The method according to claim 8,
wherein the level adjusting step controls an optical variable attenuating section comprised in each of the first optical transmitting section and the second optical transmitting section.

10. The method according to claim 8,
wherein the monitoring step monitors the level of an optical signal outputted from one of the two output ports to the optical coupling section, the optical signal being distributed by an optical distributing section provided between the one of the output ports and the optical coupling section, and the level of an optical signal directly provided from the other one of the two output ports.
